(19) United States
(12) Patent Application Publication
(10) Pub. No.: US 2011/0233129 A1
(43) Pub. Date: Sep. 29, 2011

(54) FUEL FILTER FOR MOTOR VEHICLE

(75) Inventors: Zoltan Horvath, Szekesfehervar (HU); Gabor Nyiro, Varpalota (HU)

(73) Assignee: VISTEON GLOBAL TECHNOLOGIES, INC., Van Buren Twp., MI (US)

(21) Appl. No.: 13/046,824

(22) Filed: Mar. 14, 2011

(30) Foreign Application Priority Data
Mar. 24, 2010 (HU) P1000158

(51) Int. Cl. B01D 35/14; B01D 35/02; F02M 37/22

(52) U.S. Cl. 210/243

(57) ABSTRACT

A fuel filter for motor vehicle, with a filter housing, a fuel inlet and a fuel outlet formed in the housing, as well as a cylindrical filter element arranged in the filter housing, and in a given case with terminal elements closing the ends of the filter element in a way enabling flow of the fuel, where a tubular antistatic insert is electrically connected by the internal surface of the folded paper filter element to the body potential of the vehicle as a grounding element, such that the configuration and installation of the filter element of the fuel filter is not affected.

### CROSS-REFERENCE TO RELATED APPLICATION

The present application claims priority to Hungarian Patent Application Serial Number P1000158 filed Mar. 24, 2010, the entire disclosure of which is hereby incorporated herein by reference.

### FIELD OF THE INVENTION

The subject of the invention is a vehicle fuel filter, with a filter housing, a fuel inlet and a fuel outlet formed in the housing, a cylindrical filter element arranged in the housing, and in a given case terminal elements closing the ends of the filter element in a way enabling flow of the fuel, where the filter element is electrically connected to a grounding element that is connected to the body potential of the vehicle.

### BACKGROUND OF THE INVENTION

Gasoline engine vehicles are manufactured with the use of components insulating the fuel filters that are arranged in the fuel tank or outside it, such as an insulating plastic housing and insulating filter medium. When fuel flows through the filter, electrostatic charging occurs between the combustible substance and the filter components made of insulating material. Since the filter components have insulating properties, the charge separation can create large electrostatic voltages in the filter components. In such a case, depending on the environmental conditions and the fuel quality, a voltage on the order of 20-24 kV can also be created. This large electrostatic voltage can lead to an electrostatic discharge in the form of a spark between the fuel filter components and the other parts of the vehicle, especially the fuel tank, and such a spark occurring in the fuel tank can lead to unwanted thermal events in the vehicle's fuel system.

In the case of the fuel filters used today, which also have antistatic properties, various solutions are adopted to provide a satisfactory grounding or grounding pathway for the fuel.

According to one major direction of solution, the fuel filter housing is made partly or entirely of an electrically conductive material, or made electrically conducting. One such solution is known in which the entire filter housing is made of electrically conductive plastic, as is taught, for example, by U.S. Pat. No. 5,164,879. According to another variation, only one part of the filter housing is formed from an electrically conducting plastic, such as the fuel filter of the Visteon company, registered as number VP7ALU-9N011-BA, or there is a known solution in which the filter housing is composed of at least two layers, the innermost layer being formed as an electrically conductive layer, see U.S. Pat. No. 6,453,870.

According to a second major trend, the filter element itself is made partly or entirely as an electrically conductive element, and one solution is known in which electrically conductive end caps are placed on the filter element. Such a solution is disclosed by U.S. Pat. No. 6,168,713. According to another proposal, or solution, an electrically conductive filter medium is used in the filter element, as in the case of the solution disclosed by U.S. Pat. No. 6,168,713, and there also exists a solution in which a multilayered filter medium/filter element is used, one layer of which is electrically conductive. An example of this is in EP patent specification No. 0402657 or U.S. Pat. No. 5,527,569.

Another known solution is to provide the filter fittings with electrically conductive components, such as by placing a mesh made of an electrically conductive material on the outer surface of the filter element. Such a solution is indicated by U.S. Pat. No. 6,464,870. The drawback of the solution is the relatively complicated outfitting, since the mesh must be made sufficiently rigid in order to be placed between the filter elements, while the rigidity means that the mesh does not make even contact with the filter element, and since a folded paper insert is also customary, this can get damaged. Another drawback is that the manufacturers or suppliers make the filter elements in dimensional series, and in order for the filter element to still fit inside the filter housing when provided with the mesh, the filter element has to be made with a smaller external diameter.

A common drawback of the known solutions is that the configuration of the proper grounding often requires very complex additional measures, which in the case of large numbers of parts entails substantial extra work and time expenditure, and thus, surplus costs. A further concern may be the permanent realization of the grounding, which is also influenced by the conditions of use, the materials used, and by the fuel as well.

As is known, the configuration of a fuel filter insert is determined by the available installation space, i.e., the external diameter of the filter element and the diameter of the terminal elements (caps) cannot be increased at will. Since the electrically conductive mesh needs to be galvanically connected to the terminal elements, likewise made of conductive material, the use of the mesh reduces the volume available to the filter paper used as the material of the filter element, that is, the capacity of the filter paper to absorb contaminants.

### SUMMARY OF THE INVENTION

The purpose of the invention is, in the first place, the creation of a fuel filter which can be installed in a fuel tank, for which the necessary grounding is implemented not by modifying the customary manufacturing technology, but instead with the use of a grounding element that is easily combined with manufactured, or used, filter elements, and which prevents the electrostatic charging of the fuel flowing through the fuel filter for a long time and in a broad temperature range.

The inventive fuel filter can be manufactured and installed with unchanged conditions if an element is used for the filter element that is of sufficiently large surface and antistatic effect that it neither influences significantly the flow of fuel nor modifies the dimensions accommodating the filter element, while assuring unchanged filter efficiency.

The indicated problems of the prior art are solved with a fuel filter that can be used in a motor vehicle, having a filter housing and a fuel inlet and fuel outlet formed in the filter housing. There is a cylindrical filter element disposed in the filter housing, whose ends are closed off by terminal elements which make possible a flow of fuel. A grounding element connected electrically to the body potential of the vehicle is joined to the inner surface of the filter element in a novel way.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings.

Several especially advantageous embodiments of the invention are contained in the subclaims.

The invention is explained more closely below in connection with a sample embodiment, making use of the enclosed drawings. In the drawings:

FIG. 1 is a longitudinal section of one possible embodiment of the fuel filter according to the invention, and

FIG. 2 is a cross section along line II-II of the fuel filter in FIG. 1.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

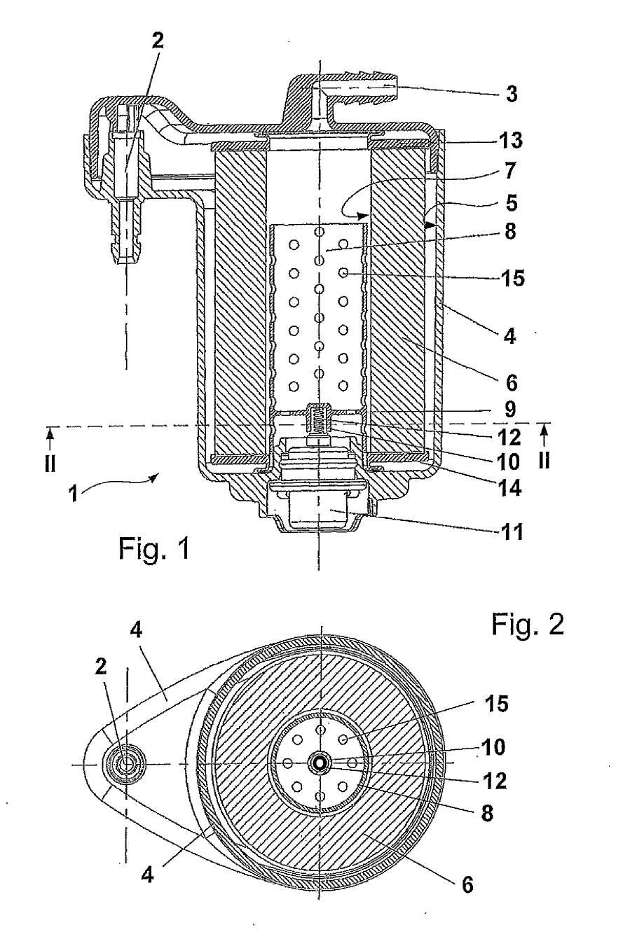

In the longitudinal section of FIG. 1 and, by way of illustration, in the cross section of FIG. 2, an embodiment of the fuel filter of the invention is shown as an advantageous example, which in no way limits the scope of protection contained in the patent claims of the invention.

By grounding, it is meant that the grounding element stands in direct, galvanic connection with a body of the motor vehicle. In the case of motor vehicles today, for the most part, a negative pole of the onboard energy sources—battery, generator, and the like—is connected directly to the metal body of the motor vehicle. But the solution of the proposed invention is not limited to motor vehicles with negative body, or other layouts having an internal combustion engine and containing the proposed filter solution in the fuel supply system.

Although an installation in a fuel tank is contemplated for the proposed filter embodiment, the fuel filter can also stand alone and produce the same results.

The sample fuel filter 1 has antistatic properties. The fuel filter 1, having at least one inlet 2 and one outlet 3, has an electrically insulating filter housing 4, made from plastic traditionally used in the technical field, and this filter housing 4 defines an internal cavity 5, in which a filter element 6 is installed. This filter element 6 is made from one or more layers of insulating material in familiar fashion. The filter element 6 itself, or the filter element 6 and the filter housing 4, define a second cavity 7, in which an antistatic insert 8 is installed. In the present example, in the bottom end region of the antistatic insert 8 in FIG. 1, inside the insert 8 and perpendicular to the longitudinal axis of the insert 8 there is formed a wall 9 from the flange material 8, and beneath the wall 9 there is formed a seat 10, open at the bottom, from the flange material in the longitudinal axis of the insert 8.

A fuel pressure regulating valve 11 of familiar construction and operation, made of electrically conducting material, is installed in the filter housing 4 at the bottom and in the center of the depicted example. The valve 11 is at the body potential, and at its apex it is in electrical contact with one end of a spring 12 made of an electrically conductive material, while the spring 12 itself extends into the seat 10 of the insert 8 and is thus, electrically connected to it. The filter element 6 consists of one or more folded filter paper layers, which terminal elements 13, 14 join together and close off at the two ends in traditional manner, at the same time ensuring in sealed manner that the fuel flowing through the fuel filter proceeds through the filter element 6.

The antistatic insert 8 is of appropriately large surface so that the fuel (not shown in the drawing) is able to be appropriately grounded. In its most simple configuration, the antistatic insert 8 is essentially a cylindrical shape, and in order to increase the surface in contact with the fuel there are a large number of openings 15 formed in the envelope surface of the cylinder, as well as in the wall 9. It will be obvious to a person having ordinary skill in the art that the surface of the insert 8 can also be increased in other known ways.

The fuel is electrically conductive or antistatic, and the antistatic insert 8 grounds the fuel present inside the filter housing 4. The grounded fuel is in electrical connection with the filter housing 4 and the individual parts of the filter element 6. Since the contact between the grounded fuel, the filter housing 4, and the filter element 6 occurs on large surfaces, the electrostatic charge forming on the filter housing 4 and the filter element 6 is drained off, so consequently, no high-voltage electrostatic field can form. If a fuel pressure regulating valve 11 is not connected to the filter housing 4, then in its place one can put a plug made of insulating or conductive material, and in this case, the grounding occurs through the spring 12 and the plug replacing the valve 11, not visible in the drawing.

The electrostatic charge created in the electrically insulating components increases at temperatures of around −40° C. The reason for this is that the resistivity of the fuel, as well as the resistivity of the plastic parts used, increases at low temperatures. Therefore, the critical environmental effect for fuel filters with antistatic properties occurs at low temperatures, characteristically in the neighborhood of −40° C. The type of fuel used can also influence the formation of the electrostatic charge. Present day alcohol-containing fuels have low resistivity, whereas fuels not containing alcohol have high resistivity. The type of fuel which can be considered critical when used together with fuel filters having antistatic property are alcohol-free fuels with large resistivity. The resistivity of fuels lies in the range of 0.05 MΩm to 20 GΩm. Therefore, the resistivity of the antistatic insert 8 must be less than 1 kΩm in order to provide an appropriate grounding path for the fuel.

The solution according to the present invention was tested with high-resistivity (16 GΩm) fuels at low temperature (−30° C.), and it was found to be able to effectively prevent the formation of the electrostatic charge on the fuel filter components. It is desirable for the surface of the antistatic insert 8 to be as large as possible in order to provide a large grounding path for the fuel in the filter housing 4.

As is evident, the components of the solution used according to the present invention differ fundamentally from the antistatic or electrically conducting components known thus far and used for grounding of the fuel present in the filter housing 4. The antistatic insert 8 with a sufficiently large surface grounds the fuel flowing through the filter fittings in such a way that the fuel found inside the fittings of the fuel filter can also be considered grounded. The grounded fuel is in contact with insulating components and parts of the filter fittings. Because the contact between the grounded fuel and the components of the filter fittings occurs on a large surface, the charges migrate from the components of the filter fittings to the fuel, and from there into the grounded antistatic insert 8. In this way, the charge accumulated in the filter fittings and/or the fuel inside the filter fittings can disappear, thereby preventing the formation of a high-voltage electrostatic field.

One of the main benefits of the proposed fuel filter is that the element providing for the grounding does not make necessary mechanical changes to the filter element 6, which can be manufactured with unchanged dimensions and technology. Thanks to its configuration, the insert 8 can be easily installed, for example, by snapping inside the filter element 6; its length is advisedly adapted to the full height of the latter, and the filter element 6 already provided with the insert 8 can be installed in the filter housing 4. The use of the insert 8 does not require closing off the two ends of the filter element 6 with fused-on plastic terminal elements, as in the solutions of the prior art, so that the layer system is not damaged. Because the inner and outer manufacturing diameter of the filter element 6 remain unchanged, the spacing between two adjacent folds of the folded paper material is not changed to its detriment, which prevents a deterioration of the filtering effect, while not producing increased resistance to the fuel flowing through the filter 1. The configuration of the new antistatic insert ensures that the fuel filter 1 can be installed without change through the fill opening in the fuel tank.

From the foregoing description, one ordinarily skilled in the art can easily ascertain the essential characteristics of this invention and, without departing from the spirit and scope thereof, make various changes and modifications to the invention to adapt it to various usages and conditions.

### LIST OF REFERENCE NUMBERS

1 fuel filter
2 inlet
3 outlet
4 filter housing
5 cavity
6 filter element
7 cavity
8 insert
9 wall
10 seat
11 valve
12 spring
13 terminal element
14 terminal element
15 opening

1. A fuel filter for a motor vehicle comprising:
a filter housing having an inlet and an outlet;
a filter element arranged in the filter housing; and
an antistatic insert arranged in the filter housing and electrically connected to the filter element, wherein the antistatic insert is electrically grounded.

2. The fuel filter according to claim 1, wherein the filter element is substantially cylindrical.

3. The fuel filter according to claim 1, wherein the antistatic insert is connected to a body of the vehicle.

4. The fuel filter according to claim 3, wherein an electric potential at the antistatic insert is substantially equal to an electric potential at the body of the vehicle.

5. The fuel filter according to claim 1, wherein the antistatic insert is joined with the filter element.

6. The fuel filter according to claim 5, wherein the antistatic insert is joined with the filter element by snapping.

7. The fuel filter according to claim 1, further comprising a pair of terminal elements closing opposing ends of the filter element to facilitate a flow of a fuel through the filter element.

8. The fuel filter according to claim 7, wherein at least one of the terminal elements secures the antistatic insert inside the filter element.

9. The fuel filter according to claim 1, wherein an outer surface of the antistatic insert is fitted to an inner surface of the filter element.

10. The fuel filter according to claim 1, wherein the antistatic insert is substantially tubular.

11. The fuel filter according to claim 1, wherein the antistatic insert includes a plurality of openings formed therein.

12. The fuel filter according to claim 1, further comprising a spring formed from an electrically conducting material, the spring providing electrical communication between the antistatic insert and a body of the vehicle.

13. The fuel filter according to claim 12, wherein the antistatic insert includes a seat formed therein abutting the spring.

14. The fuel filter according to claim 13, wherein the seat is arranged coaxially with the antistatic insert.

15. The fuel filter according to claim 12, further comprising a fuel pressure regulating valve disposed in the filter housing and providing electrical communication between the spring and the body of the vehicle.

16. The fuel filter according to claim 1, wherein the filter element is a hollow cylinder forming a cavity, and wherein the antistatic insert is disposed in the cavity.

17. A fuel filter for a motor vehicle comprising:
a filter housing having an inlet and an outlet;
a filter element arranged in the filter housing;
a pair of terminal elements closing opposing ends of the filter element to facilitate a flow of a fuel through the filter element; and
an antistatic insert arranged in the filter housing and electrically connected to the filter element, wherein the antistatic insert is connected to a body of the vehicle.

18. The fuel filter according to claim 17, wherein an electric potential at the antistatic insert is substantially equal to an electric potential at the body of the vehicle.

19. The fuel filter according to claim 17, wherein the antistatic insert includes a plurality of openings formed therein.

20. A fuel filter for a motor vehicle comprising:
a filter housing having an inlet and an outlet;
a filter element arranged in the filter housing;
an antistatic insert arranged in the filter housing and electrically connected to the filter element; and
a fuel pressure regulating valve disposed in the filter housing and providing electrical communication between the antistatic insert and a body of the vehicle, wherein an electric potential at the antistatic insert is substantially equal to an electric potential at the body of the vehicle.
